(19) United States
(12) Patent Application Publication
(10) Pub. No.: US 2018/0157690 A1
(43) Pub. Date: Jun. 7, 2018

(54) DATA PUBLISHING SERVICE WITH LOW-LATENCY READ ACCESS

(71) Applicant: Facebook, Inc., Menlo Park, CA (US)

(72) Inventors: Adela Kabiljo, Redwood City, CA (US); Qi Hu, Union City, CA (US); Pol Mauri Ruiz, Redwood City, CA (US); Prashasti Baid, Mountain View, CA (US); Shuai Shao, San Bruno, CA (US); Jichuan Lu, San Mateo, CA (US); Yingxian Wang, Palo Alto, CA (US); Hong Yan, Los Altos, CA (US); Volodymyr Krestiannykov, Menlo Park, CA (US); Chunqiang Tang, San Jose, CA (US)

(21) Appl. No.: 15/366,910

(22) Filed: Dec. 1, 2016

(51) Int. Cl. G06F 17/30; H04L 29/08

(52) U.S. Cl. CPC G06F 17/30321; H04L 67/1097; G06F 17/30486; G06F 17/30569

(57) ABSTRACT

The disclosure is directed to a data publishing service that provides a low-latency read access to data. Some applications store data in a format that is not suitable or efficient for retrieving the data in real-time or near real-time. The data publishing service converts the data into a format, e.g., key-value pairs, that provides a low-latency read access to the data. A low-latency read access is a feature that enables retrieval of data in real-time, near real-time, or within a specified read latency. The data publishing service also provides an application programming interface (API), which can be used by a client for accessing the data. The data publishing service can be used to provide low-latency read access to data stored in data sources of various storage formats, e.g., data stored in relational database, log files, or as objects in object-oriented databases.

### BACKGROUND

Some applications manage a significant amount of data. For example, a social networking application typically has a large number of users, e.g., in the order of several millions, and the amount of user data the application may have to manage is significantly large. The social networking application can store the data in various formats, e.g., in a relational database, in a log file, as data objects in an object oriented database, and as comma separated values. A large amount of the data is typically stored in a format that is optimized for offline retrieval, e.g., data retrieval in which read latency is not a priority. As the applications evolve, more and more features in the applications are demanding access to such offline data in real-time or near real-time. However, the applications lack the capability to optimize such offline data for retrieval in real-time or near real-time.

### BRIEF DESCRIPTION OF THE DRAWINGS

FIG. 1 is a block diagram of an environment in which the disclosed embodiments may be implemented.

FIG. 2 is a block diagram of a server of a data publishing service, consistent with various embodiments.

FIG. 3A is a block diagram of an example illustrating generation of key-value pairs and shards, consistent with various embodiments.

FIG. 3B is a block diagram of an example illustrating assignment of shards to the publisher nodes, consistent with various embodiments.

FIG. 4 is a block diagram illustrating an example of processing a data access request from a client, consistent with various embodiments.

FIG. 5 is a flow diagram of a process for preparing an application to provide low-latency read access to its data, consistent with various embodiments.

FIG. 6 is a flow diagram of a process for processing a data access request for a specified value from a client, consistent with various embodiments.

FIG. 7 is a block diagram of a processing system that can implement operations, consistent with various embodiments.

### DETAILED DESCRIPTION

Embodiments are directed to a data publishing service that provides a low-latency read access to data. Some applications store data in a format that is not suitable or efficient for retrieving the data in real-time or near real-time. The data publishing service converts the data into a format, e.g., key-value pairs, that provides a low-latency read access to the data. A low-latency read access is a feature that enables retrieval of data in real-time, near real-time, or within a specified read latency. The data publishing service also provides an application programming interface (API) for accessing the data. The data publishing service can be used to provide low-latency read access to data stored in data sources of various storage formats, e.g., data stored in relational database, data stored as comma separated values, data stored as objects in object-oriented databases, data stored in log files.

An application, e.g., a social networking of application, or a service of the application, e.g., messaging service, can register with the data publishing service to provide access to or publish its data with low read latency. A server computing device (“server”) can use the information in registration data provided by the application for preparing or converting data items associated with the application to key-value pairs for providing low-latency read access. For example, if the application stores the data in a relational database, the application can provide in the registration data information regarding (a) a table in which the data items are stored, (b) a first set of columns of a table to be considered as a key, and (c) a second set of columns of the table to be considered as a value of the key. The server can then convert the data items in all the rows of the table to key-value pairs. For example, for a specified row, the server can combine data values in the first set of columns to form a key and combine data values in the second set of columns to form a value of the key. The server can use a specified key generation function to combine the data values in the first set of columns to form the key, and a value generation function to combine the data values in the second set of columns to form the value. The key generation function and the value generation function can be specified by the application, data publishing service, a user associated with the application and/or the data publishing service, or a combination thereof.

After the key-value pairs are generated, the server partitions the key-value pairs into multiple shards in which each shard includes a subset of the key-value pairs. A shard is like a data partition that includes a subset of the entirety of data stored in a storage system. Different applications can shard or partition the data in different ways. For example, a social networking application can partition data associated with a first hundred users into a first shard, data associated with a second hundred users into a second shard and so on. The server stores each of the shards in a key-value storage system.

After the server generates the shards, the server assigns different shards to different publisher nodes. Each publisher node hosts a subset of the shards and serves data access requests for data items stored in the shards hosted by the corresponding publisher node. A client computing device (“client”) can issue a data access request using the API of the data publishing service. To access a specified data item, the client can specify a key whose value is to be accessed to the server. The server determines a specified publisher node that hosts the shard containing the key and returns access information of the specified publisher node, e.g., Internet Protocol (IP) address and a port, to the client. Using the access information, the client can send the data access request to the specified publisher node and obtain the specified data item, e.g., a value associated with the provided key, in real-time, near real-time, or within a specified latency. By facilitating accessing the data items, e.g., offline data stored in a format not suitable for fast retrieval or retrieval in real-time or near real-time, as key-value pairs, the data publishing service provides a low-latency read access to the data.

The server can synchronize the key-value storage system with the data source of the application to keep the key-value storage system updated with any changes in the data source of the application. For example, any additions of a new data item or changes to any existing data items in the database at which the application stores the data is synchronized with the key-value storage system to add new key-value pairs and/or change the existing key-value pairs. The synchronization is initiated based on a trigger, e.g., expiry of a time interval, a number of data items changed and/or added to the data source of the application exceeds a specified threshold, and the change in size of the data source exceeds a specified threshold.

In some embodiments, more than one application can register with the data publishing service to provide low-latency read access to their data. The publisher node is implemented in a multi-tier fashion for supporting low-latency read accesses to data of various applications. In some embodiments, a tier is a set of shards associated with a specified application. A publisher node can host shards from different tiers, e.g., different applications. The data access request issued by the client can include both the application information, e.g., application ID, and the key whose data the client wishes to retrieve.

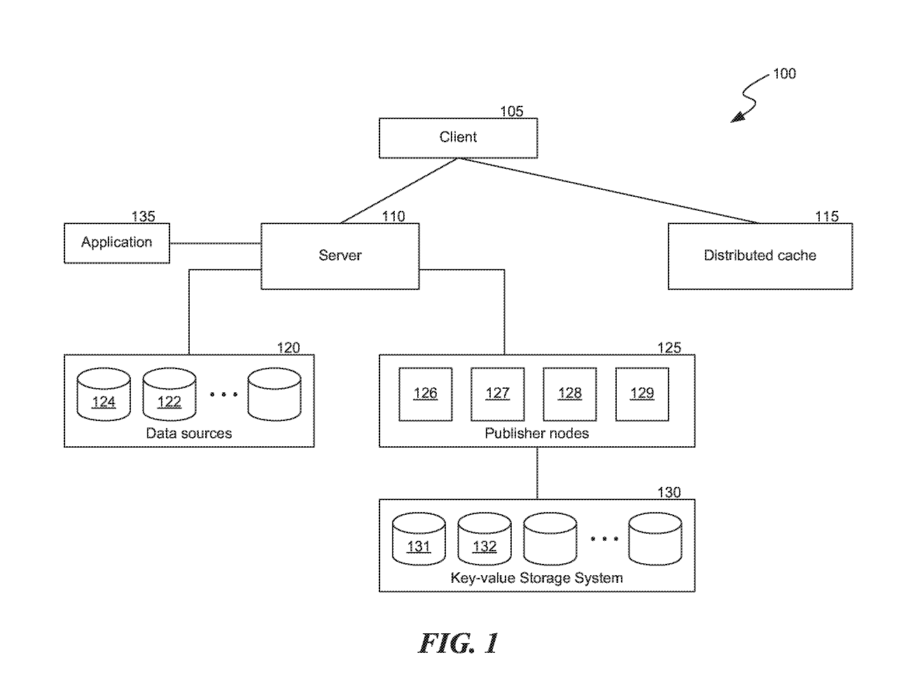

Turning now to the figures, FIG. 1 is a block diagram of an environment 100 in which the disclosed embodiments may be implemented. The environment 100 includes a server 110, publisher nodes 125 and key-value storage system 130 all of which together form a data publishing service. The data publishing service enables an application 135 to provide low-latency read access to the data associated with the application 135. A client 105 can consume the data associated with the application 135 in real time or near-real time using the data publishing service, which otherwise would not have been possible.

The application 135 can be a social networking application or a service in a social networking application, e.g., a messenger service. The application 135 can provide low-latency read access to its data through the data publishing service. The application 135 can publish different types of data. For example, the application 135 can store data such as a social rank and a social rank score of a user. Some clients may want to consume such a data in real-time. However, the data may be stored in a format that is not suitable for real-time access. For example, the application 135 may store its data items in a relational database, such as a first data source 121, which is less efficient for retrieving data from in real-time. The application 135 can register with the data publishing service to provide real time access to such data.

A data source 120 can store data items associated with applications such as the application 135. The data source 120 can include various types of storage management systems, all of which may store the data items in a format that is not suitable for real-time access. For example, a first data source 121 can be a relational database and a second data source 122 can be a log file.

The data publishing service can provide low-latency read access for data items that stored in the data source 120. The application 135 can register with the server 110 for providing low-latency read access to the data items. Upon registration, the server 110 can prepare the data for low-latency read access, which can include converting the data items in the first data source 121 to key-value pairs (or generating the key-value pairs from the data items stored in the first data source 121). During registration, the application 135 provides registration data to the server 110, which includes information regarding a source of the data items, a set of attributes of a data item that is to be considered as a key and a set of attributes of the data item that is to be considered as a value. The server 110 can convert the data items to key-value pairs based on the registration data. In some embodiments, storing the data items as key-value pairs facilitates a low-latency read access.

The server 110 partitions the key-value pairs into multiple shards and stores each of the shards in a key-value store, e.g., a first key-value store 131 of a key-value storage system 130. Each shard includes a subset of the key-value pairs. The server 110 assigns different shards to different publisher nodes 125. For example, shards “S1” and “S6” are assigned to a first publisher node 126 and shards “S3” and “S5” to a second publisher node 127 and so on. The first publisher node 126 can respond to a data access request for any of the key-values stored in the shards “S1” and “S6.” In some embodiments, the server 110 can replicate the shards and assign a replica shard to a publisher node other than the one storing the original shard. For example, while the shard “S1” is assigned to the first publisher node 126, a replica of the shard “S1” can be assigned to a third publisher node 128.

When the server 110 receives a data access request from the client 105, the server 110 extracts a key (and application ID) from the request, determines a specified shard in which the key is stored, determines a set of publisher nodes hosting the specified shard, selects a specified publisher node from the set of publisher nodes, and returns access information, e.g., IP address and port, of the specified publisher node to the client 105. The client 105 can then access the specified publisher node, e.g., using the access information, to obtain a value associated with the key. For example, the application 135 can store data such as a social rank and a social rank score of a user. The first key-value store 131 can store a user ID of the user as a key, and the value as “<score>, <rank>” of the user. The client 105 can use the API provided by the data publishing service to access the data, e.g., value associated with the key. In the data access request API, the client 105 can provide the user ID as a key, and receive the social rank and score as the value in the format of “<score>,<position>.” So given a user ID, the specified publisher node returns the user's social rank score and his/her rank in social rank. Note that the key can include attributes in addition to or other than the user ID.

In some embodiments, the key-value pairs can be cached in a distributed cache 115. When the client 105 requests a value of a specified key, the specified publisher node and/or the server 110 checks the distributed cache 115 for the key-value pair and if it is available, the specified publisher node and/or the server 110 returns the specified value to the client 105 from the distributed cache 115. If the specified value is not available in the distributed cache 115, then it is retrieved from the first key-value store 131. The server 110 can cache the key-value pairs in the distributed cache 115 using various caching policies, e.g., most frequently accessed caching policy. The distributed cache 115 can be implemented on a single machine or more than one machine. The distributed cache 115 is typically of a storage medium that has lower read latency than that of the key-value storage system 130.

The data publishing service can be implemented in a data center scenario. For example, the publisher nodes 125 can be spread across multiple data centers, which are in turn spread across various geographical locations.

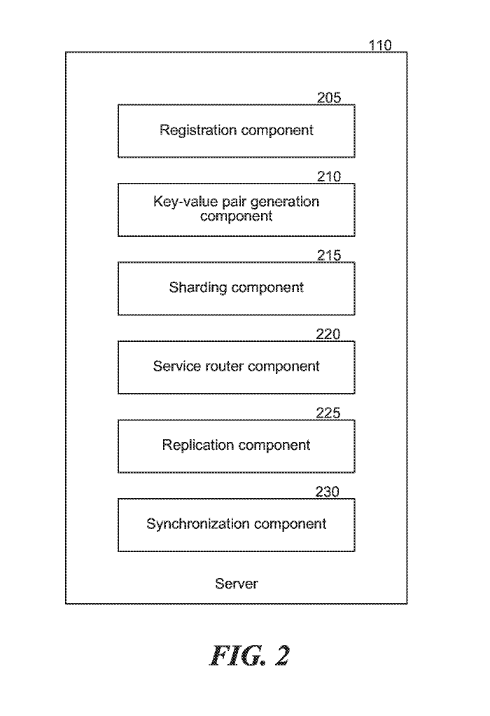

FIG. 2 is a block diagram of the server 110 of the data publishing service of FIG. 1, consistent with various embodiments. The server 110 includes a registration component 205 that facilitates registration of an application, e.g., the application 135, with the data publishing service. The registration component 205 extracts information necessary for converting the data items of the application 135 to the key-value pairs from the registration data. For example, the registration component 205 extracts the data source information of the application 135, e.g., a name of a database table in which the data items of the application 135 are stored in the first data source 121. Continuing with the example, the registration component 205 extracts a first set of attributes of a data item that is to be considered as a key, e.g., a first set of columns of the table that is to be considered as a key, and extracts a second set of attributes of the data item that is to be considered as a key, e.g., a second set of columns of the table that is to be considered as the value of the key. In some embodiments, the registration component 205 may also extract the application ID from the registration data. The registration data can include any other information necessary for generating the key-value pairs.

The server 110 includes a key-value pair generation component 210 that generates the key-value pairs for the data items of the application 135. The key-value pair generation component 210 can generate the key-value pairs from the data items stored in the first data source 121 based on the registration data. For example, for a specified data item, “d1,” in the first data source 121, the key-value pair generation component 210 can generate a key, “k1,” by combining the values from the first set of columns to be considered as the key. If columns C1 and C2 of a table are to be considered as a key, then the values “a1” and “a2” in those respective columns are combined to generate the key, “k1.” The key-value pair generation component 210 can use any key-generation function for combining the values to generate the key, “k1.” For example, the key-generation function can concatenate the values of the respective columns with a comma between them to form the key, e.g., k1=“a1,a2.” In some embodiments, the key-generation function can be defined to combine the values “a1” and “a2” to generate a single value, e.g., “x1.” The key-generation function can be defined by a user associated with the application 135.

The key-value pair generation component 210 can similarly generate the value, “v1,” for the associated key, “k1.” For example, for the specified data item, “d1,” the key-value pair generation component 210 can generate the value, “v1” by combining the values from the second set of columns to be considered as the value. If columns C5, C6 and C7 of the table are to be considered as the value, then the values “a5,” “a6,” and “a7” in those respective columns are combined to generate the value, “v1” for the key, “k1.” The key-value pair generation component 210 can use any value-generation function for combining the values to generate the value of the key, “v1.” For example, the value-generation function can concatenate the values of the respective columns with a comma between them to form the value, e.g., v1=“a5,a6,a7.” In some embodiments, the value-generation function can be defined to combine the values “a5,” “a6” and “a27” to generate a single value, e.g., “y1.” The value-generation function can be defined by the user associated with the application 135. Using the method described above, the key-value pair generation component 210 can generate the key-value pairs for all the data items associated with the application 135 that are stored in the first data source 121.

The server 110 includes a sharding component 215 that partitions the key-value pairs, e.g., generated by the key-value pair generation component 210, to multiple shards. Each shard can include a subset of the generated key-value pairs. For example, the sharding component 215 can partition a first one hundred of the key-value pairs into a first shard “S1,” a second one hundred of the key-value pairs into a second shard “S2” and so on. The sharding component 215 can use any sharding function to partition the key-value pairs. For example, if the key-value pairs are associated with users of a social networking application, the sharding component 215 can partition key-value pairs associated with users having user ID “1” to user ID “100” into a first shard, “S1,” users with user ID “101” to user ID “200” into a second shard, “S2” and so on. In another example, the sharding component 215 can partition key-value pairs associated with users located in a first geographical region into a first shard, “S1,” users located in a second geographical region into a second shard, “S2” and so on. The sharding component 215 stores each of the shards in a separate key-value store.

After the sharding component 215 partitions the key-value pairs into multiple shards, the sharding component 215 assigns the shards to the publisher nodes 125. The sharding component 215 can assign different shards to different publisher nodes. For example, the sharding component 215 can assign shard “S1” to the first publisher node 126, shard “S2” to the second publisher node 127, and so on. The sharding component 215 can use a number of assignment functions to assign the shards to the publisher nodes 125. For example, the sharding component 215 can assign shards to the publisher nodes 125 on a random basis. In another example, the sharding component 215 can assign shards that are associated with users of a first geographical region to publisher nodes that are configured to serve data access requests from the users in the first geographical region. In some embodiments, the sharding component 215 can maintain the shard assignments to the publisher nodes 125 in a shard assignment map. The assignment function can be defined by the user associated with the application 135 and/or the server 110.

The server 110 includes a service router component 220 that routes a data access request from the client 105 to an appropriate publisher node. In some embodiments, each of the publisher nodes 125 publishes a list of the shards assigned to or hosted by the corresponding publisher node to the service router component 220. The service router component 220 can maintain the list of shards hosted by publisher nodes 125 in the shard assignment map. The service router component 220 can either update the shard map maintained by the sharding component 215 or generate a new one to maintain the assignment information received from the publisher nodes 125. A data access request issued by the client 105 can include a key the value of which the client 105 needs to retrieve. The data access request can also include the application ID to which the key belongs. When the server 110 receives the data access request from the client 105, the service router component 220 extracts the key and the application ID, and determines a specified shard with which the key of the application is associated. After determining the specified shard, the service router component 220 determines a specified publisher node that hosts the specified shard and returns the access information of the specified publisher node, e.g., IP address and port, to the client 105. The client 105 can then request the specified publisher node to return the value associated with the key provided in the data access request.

In some embodiments, the specified shard may be assigned to a set of the publisher nodes. The service router component 220 can determine which of the set of publisher nodes the data access request is to be assigned based on various factors, e.g., load of a publisher node and an average read latency associated with the publisher node.

The server 110 includes a replication component 225 that replicates the shards generated by the sharding component 215. In some embodiments, the shards are replicated for providing redundancy, high availability, recovering from a failure of the key-value store storing a specified shard, etc. The sharding component 215 can assign the replicas to publisher nodes different from the ones hosting the original shards. For example, if a first shard “S1” is hosted by the first publisher node 126, the sharding component 215 can assign the replica of the first shard “S1” to a fourth publisher node 129. The replica shards are assigned to the publisher nodes different from the ones hosting the original shards for providing redundancy, high availability, recovering from a failure of the publisher node hosting a specified original shard, etc.

The server 110 includes a synchronization component 230 that synchronizes the key-value storage system 130 with the data sources 120 to update the key-value storage system 130 with any changes to the data items associated with the application 135. For example, the synchronization component 230 synchronizes any addition of a new data item or changes to any existing data items in the first data source 121 at which the application 135 stores the data items with the key-value storage system 130 to add new key-value pairs and/or change the existing key-value pairs. The synchronization component 230 initiates the synchronization based on a trigger, e.g., expiry of a time interval, a number of data items changed and/or added to the first data source 121 exceeds a specified threshold, and the change in size of the data source exceeds a specified threshold.

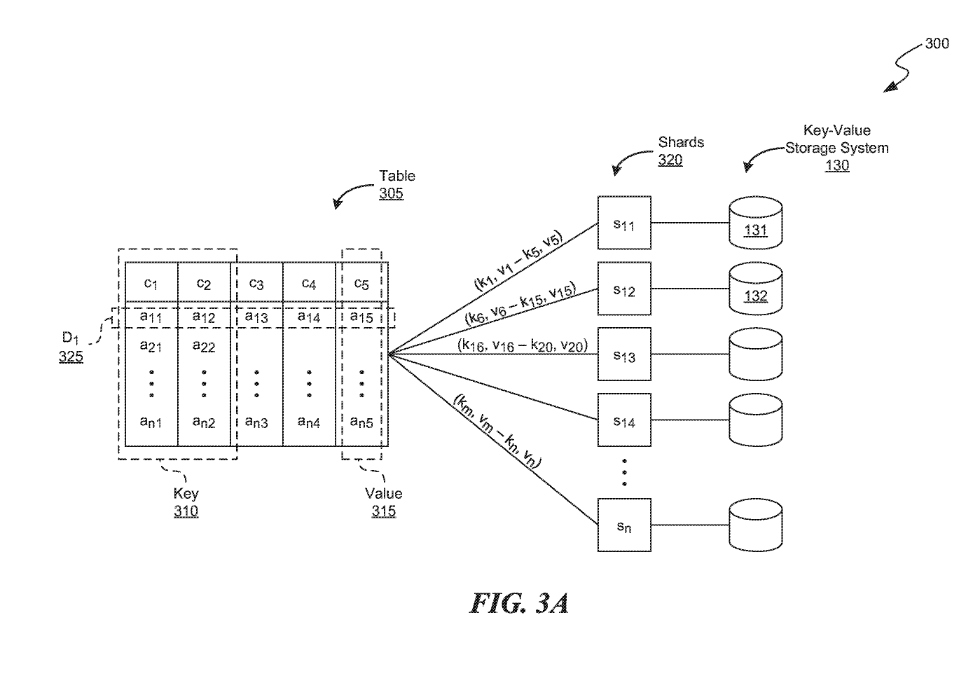

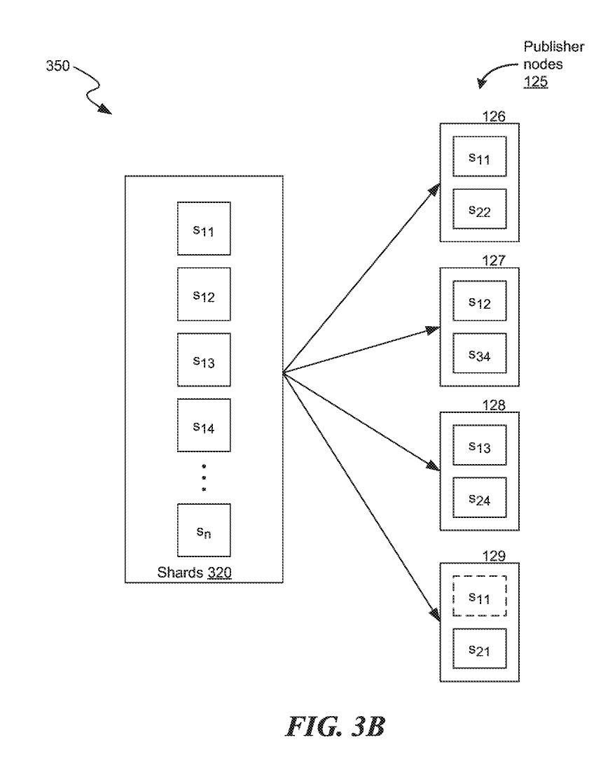

FIG. 3A is a block diagram of an example 300 illustrating generation of key-value pairs and shards, consistent with various embodiments. In the example 300, the data items associated with an application, e.g., the application 135 are stored in a database table 305. Each of the rows in the database table 305 represents a data item associated with the application 135. For example, a first row 325 represents a first data item “D1.” Each of the columns, “C1”-“C5,” of the database table 305 represents an attribute of the data item.

In the example 300, the application 135 has indicated that columns “C1” and “C2” are to be considered as a key, and a column “C5” is to be considered as a value of the key. Accordingly, for the first data item, “D1,” the server 110 generates a key, k1, as a function of “a11” and “a12” in the columns “C1” and “C2,” and generates the value, v1, as a function of “a15” in the column “C5,” thus, generating a key-value pair (k1, v1) corresponding to the data item “D1,” as described above at least with reference to FIG. 2. The server 110 similarly generates key-value pairs for the rest of the data items in the database table 305, e.g., key-value pairs “k₁,v₁”-“kₙ,vₙ”.

After the key-value pairs are generated, the server 110 partitions the key-value pairs “k₁,v₁”-“kₙ,vₙ” to multiple shards 320, e.g., shards “S₁₁”-“S₁ₙ.” Each of the shards 320 includes a subset of these key-value pairs. Note that the server 110 can facilitate low-latency read access to multiple applications. Accordingly, in some embodiments, different sets of shards can be created for different applications. For example, the server 110 generates shards “S₁₁”-“S₁ₙ” for the application 135 with application ID “1,” and generates shards “S₂₁”-“S₂ₙ” for another application with application ID “2.” Each of the shards 320 is stored in a separate instance of the key-value store. For example, the shard “S₁₁” is stored in the first key-value store 131, “S₁₂” is stored in a second key-value store 132 and so on.

FIG. 3B is a block diagram of an example 350 illustrating assignment of shards to the publisher nodes, consistent with various embodiments. In the example 350, the shards 320 are assigned to a number of publisher nodes 125. In some embodiments, a publisher node hosts a subset of the shards 320. For example, the first publisher node 126 hosts shard “S₁₁,” the second publisher node 127 hosts shard “S₁₂.” In some embodiments, a publisher node can host a shard from more than one tier, e.g., application. For example, the first publisher node 126 hosts shard “S₁₁” associated with an application having application ID “1” and shard “S₂₂” associated with an application having application ID “2.”

In some embodiments, the server 110 also assigns a replica of the shard to a publisher node different from the one hosting the original shard. For example, while shard “S₁₁” is hosted by the first publisher node 126, a replica of the shard “S₁₁” is hosted by the fourth publisher node 129. As described above at least with reference to FIG. 2, the assignments of the shards to the publisher nodes can be performed by the sharding component 215 and/or the service router component 220.

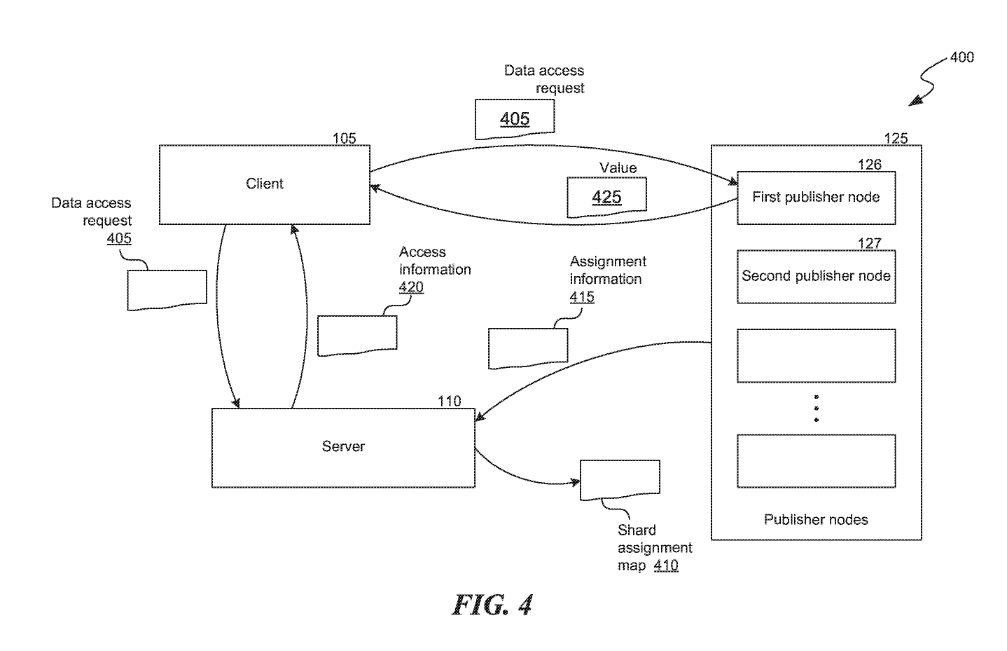

FIG. 4 is a block diagram illustrating an example 400 of processing a data access request from a client, consistent with various embodiments. The client 105 can issue a data access request 405 to the data publishing service for obtaining a specified data item, using an API provided by the data publishing service. In some embodiments, the API requires the client 105 to specify a key and an application ID of the application associated with the specified data item in the data access request 405. The server 110 retrieves a value associated with the key and returns the value as the specified data item to the client 105.

When the data access request 405 is received at the server 110, the server 110 determines a specified shard with which the key specified in the data access request 405 is associated. The server 110 can determine the specified shard based on the key and the application ID. After determining the specified shard, the server 110 can determine one or more of the publisher nodes 125 that is hosting the specified shards. In some embodiments, the server 110 can use the shard assignment map 410, which includes assignments of the shards to the publisher nodes 125, to determine the publisher nodes hosting the specified shard. In some embodiments, each of the publisher nodes 125 sends the assignment information 415, e.g., a set of shards hosted by the corresponding publisher node, to the server 110. The publisher nodes 125 can send the assignment information 415 to the server 110 on a regular basis and/or upon a change in assignment with respect to the corresponding server. Referring back to the determination of the publisher nodes 125 hosting the specified shard, if there is more than one publisher node hosting the specified shard, the server 110 determines which of the publisher nodes should be selected to serve the data access request 405, e.g., as described at least with reference to FIG. 2.

After determining the publisher node that is to serve the data access request 405, the server 110 sends access information 420 of the selected publisher node, e.g., IP address and port number, to the client 105. The client 105 can send the data access request 405 to the selected publisher node, e.g., the first publisher node 126, based on the access information 420. The first publisher node 126 retrieves the key from the data access request 405, obtains the value 425 associated with the key from the specified shard, and returns the value 425 as the requested data item to the client 105.

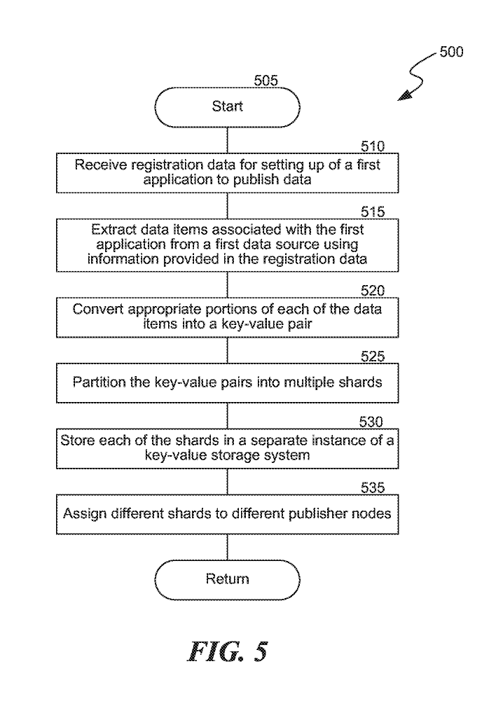

FIG. 5 is a flow diagram of a process 500 for preparing an application to provide low-latency read access to its data, consistent with various embodiments. In some embodiments, the process 500 may be implemented in the environment 100 of FIG. 1. The process 500 begins at block 505, and at block 510, the registration component 205 receives a registration request from an application, e.g., the application 135 for registering the application 135 to provide low-latency read access to its data. The registration request provides registration data that includes information necessary for converting data items of the application 135 to key-value pairs, e.g., a name of a database table in which the data items of the application 135 are stored, a first set of columns of the table that is to be considered as a key, and a second set of columns of the table that is to be considered as the value of the key.

At block 515, the key-value pair generation component 210 extracts the data items associated with the application 135 from a data source specified in the registration data.

At block 520, the key-value pair generation component 210 converts appropriate portions of each of the data items to a key-value pair. For example, for a first data item, the key-value pair generation component 210 converts the values in the first set of columns to a key, “k1,” and the values in the second set of columns to a value associated with the key, “v1.” The key-value pair generation component 210 can generate the key-value pairs for all the data items associated with the application 135 that are stored in the data source.

At block 525, the sharding component 215 partitions the key-value pairs, e.g., generated in block 520, to multiple shards. Each of the shards can include a subset of the generated key-value pairs.

At block 530, the sharding component 215 stores each of the shards in a separate instance of the key-value store. For example, the shard “S₁₁” is stored in the first key-value store 131, “S₁₂” is stored in the second key-value store 132 and so on.

At block 535, the sharding component 215 assigns the shards, e.g., generated in block 525, to the publisher nodes 125, and the process 500 returns. Each of the publisher nodes 125 can host a subset of the shards. The sharding component 215 can use a number of assignment functions to assign the shards to the publisher nodes 125. For example, the sharding component 215 can assign shards to the publisher nodes 125 on a random basis. In another example, the sharding component 215 can assign shards that are associated with users of a first geographical region to publisher nodes that are configured to serve data access requests from the users located in the first geographical region. In some embodiments, the sharding component 215 can maintain the shard assignments to the publisher nodes 125 in a shard assignment map.

Additional details with respect to the process 500 are also described at least with reference to FIGS. 2, 3A and 3B above.

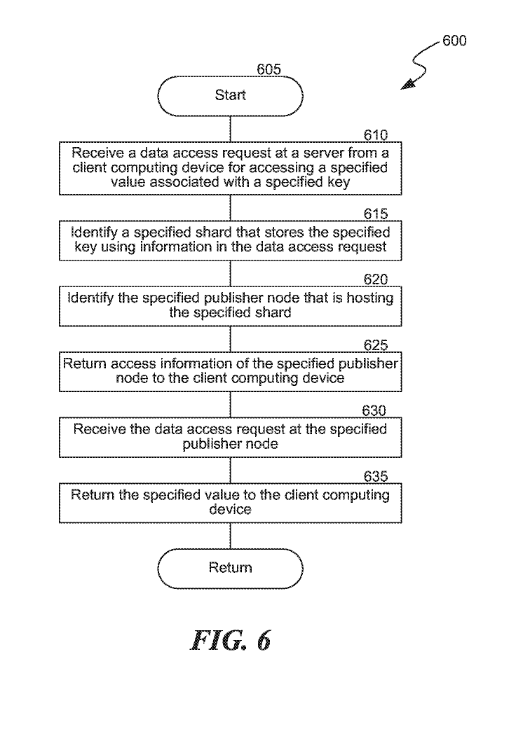

FIG. 6 is a flow diagram of a process 600 for processing a data access request for a specified value from a client, consistent with various embodiments. In some embodiments, the process 600 may be implemented in the environment 100 of FIG. 1. The process 600 begins at block 605, and at block 610, the service router component 220 receives a data access request from the client 105. The data access request can include a specified key and the application ID of the application with which the specified value is associated.

At block 615, the service router component 220 determines a specified shard in which the specified key is stored. For example, the service router component 220 extracts the key and the application ID from the data access request, and identifies the specified shard with which the key of the application is associated.

At block 620, the service router component 220 determines a specified publisher node that hosts the specified shard. In some embodiments, the specified shard may be assigned to a set of the publisher nodes. The service router component 220 can determine which of the set of publisher nodes the data access request is to be assigned based on various factors, e.g., load of a publisher node and an average read latency associated with the publisher node.

At block 625, the service router component 220 returns access information of the specified publisher node, e.g., IP address and port number, to the client 105. The client 105 can then forward the data access request to the specified publisher node.

At block 630, the specified publisher node receives the data access request from the client 105.

At block 635, the specified publisher node retrieves the key from the data access request, obtains the specified value of the key from the specified shard, and returns the specified value to the client 105.

Additional details with respect to the process 600 are also described at least with reference to FIGS. 2, and 4 above.

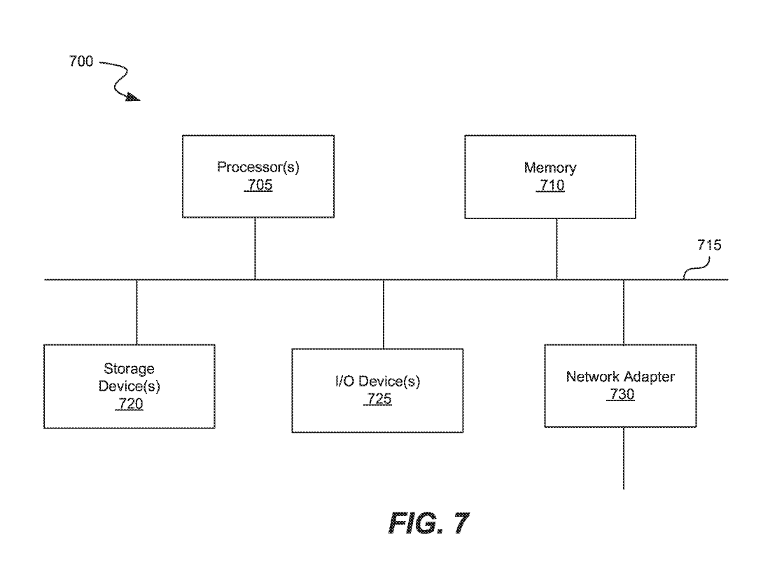

FIG. 7 is a block diagram of a computer system as may be used to implement features of the disclosed embodiments. The computing system 700 may be used to implement any of the entities, components, modules, systems, or services depicted in the examples of the foregoing figures (and any other entities described in this specification). The computing system 700 may include one or more central processing units (“processors”) 705, memory 710, input/output devices 725 (e.g., keyboard and pointing devices, display devices), storage devices 720 (e.g., disk drives), and network adapters 730 (e.g., network interfaces) that are connected to an interconnect 715. The interconnect 715 is illustrated as an abstraction that represents any one or more separate physical buses, point to point connections, or both connected by appropriate bridges, adapters, or controllers. The interconnect 715, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 710 and storage devices 720 are computer-readable storage media that may store instructions that implement at least portions of the described embodiments. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non transitory” media).

The instructions stored in memory 710 can be implemented as software and/or firmware to program the processor(s) 705 to carry out actions described above. In some embodiments, such software or firmware may be initially provided to the processing system 700 by downloading it from a remote system through the computing system 700 (e.g., via network adapter 730).

The embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a specified feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/We claim:

1. A computer-implemented method, comprising:
receiving, at a server computing device, registration data of a first application for setting up the first application to publish data, wherein the first application stores data as multiple data items in a first data source and each data item has multiple attributes;
converting, by the server computing device and based on the registration data, the multiple data items into multiple key-value pairs, wherein the multiple key-value pairs include a key-value pair corresponding to a data item of the multiple data items, wherein a key of the key-value pair is generated based on a first set of attributes of the data item, and wherein a value associated with the key is generated based on a second set of multiple attributes of the data item;
partitioning, by the server computing device, the multiple key-value pairs into multiple shards, wherein a shard of the multiple shards includes a subset of the key-value pairs and is stored in a key-value storage system; and
assigning, by the server computing device, different shards to different publisher nodes.

2. The computer-implemented method of claim 1 further comprising:
receiving, at the server computing device, a data access request from a client computing device for obtaining a specified value, the data access request including a specified key with which the specified value is associated, the specified value being a portion of a specified data item of the first application;
retrieving, by the server computing device, the specified value from a specified publisher node of the multiple publisher nodes that stores the specified value; and
returning, by the server computing device, the specified value to the client computing device.

3. The computer-implemented method of claim 2, wherein retrieving the specified value includes:
identifying a specified shard of the multiple shards with which the specified key is associated,
identifying the specified publisher node that is hosting the specified shard, and
requesting the specified publisher node to return the specified value.

4. The computer-implemented method of claim 3, wherein identifying the specified shard includes retrieving or otherwise deriving a shard identifier (ID) of the specified shard based on the specified key.

5. The computer-implemented method of claim 3, wherein identifying the specified publisher node includes:
determining, based on a shard map having assignments of the multiple shards to the multiple publisher nodes, a set of publisher nodes to which the specified shard is assigned, and
selecting at least one publisher node from the set of publisher nodes as the specified publisher node.

6. The computer-implemented method of claim 3, wherein identifying the specified publisher node includes:
receiving, at the server computing device and from each of the publisher nodes, a list of shards hosted by the corresponding publisher node.

7. The computer-implemented method of claim 2, wherein retrieving the specified value includes:
determining, by the server computing device, access information of the specified publisher node, and
returning, by the server computing device, the access information to the client computing device.

8. The computer-implemented method of claim 7 further comprising:
receiving, at the specified publisher node, the data access request from the client computing device, and
returning, by the specified publisher node, the specified value to the client computing device.

9. The computer-implemented method of claim 2, wherein retrieving the specified value includes:
retrieving a first value from a first publisher node of the multiple publisher nodes and a second value from a second publisher node of the multiple publisher nodes, and
aggregating, based on an aggregation function, the first value and the second value to generate the specified value.

10. The computer-implemented method of claim 1, wherein assigning different shards to different publisher nodes includes:
assigning at least one shard from a first tier and at least one shard from a second tier to a specified publisher node of the multiple publisher nodes, wherein the first tier corresponds to a set of shards of the first application and the second tier corresponds to a set of shards of a second application.

11. The computer-implemented method of claim 1, wherein assigning different shards to different publisher nodes includes:
storing a replica of a shard hosted by one of the multiple publisher nodes at the key-value storage system, and
assigning the replica of the shard to another one of the multiple publisher nodes.

12. The computer-implemented method of claim 1, wherein the registration data includes information indicating that the first set of attributes of the data item is to be considered as the key and the second set of attributes is to be considered as the value associated with the key.

13. The computer-implemented method of claim 1, wherein the first data source is a database table, and wherein the registration data includes information indicating that a first set of columns of the database table is to be considered as the key and a second set of columns of the database table is to be considered as the value associated with the key.

14. The computer-implemented method of claim 1, wherein converting the multiple data items to the multiple key-value pairs includes synchronizing the first data source with the key-value storage system to update the key-value storage system with modifications in the first data source.

15. The computer-implemented method of claim 14, wherein the synchronizing is performed base on a triggering event, the triggering event including one or more of an expiry of a time interval, upon modification to any of the multiple data items, or addition of new data items to the first data source.

16. A computer-readable storage medium storing computer-readable instructions, comprising:
instructions for converting, by the server computing device, multiple data items in a first data source into multiple key-value pairs, wherein the multiple key-value pairs include a key-value pair corresponding to a data item of the multiple data items, wherein a key of the key-value pair is generated based on a first set of attributes of the data item, and wherein a value associated with the key is generated based on a second set of attributes of the data item, wherein the first data source stores the multiple data items in a format different than that of the key-value pairs;
instructions for partitioning, by the server computing device, the multiple key-value pairs into multiple shards, and assigning different shards to different publisher nodes;
instructions for receiving, by the server computing device, a data access request from a client computing device for obtaining a specified value associated with a specified key, the data access request including the specified key;
instructions for retrieving, by the server computing device, the specified value from a specified publisher node of the publisher nodes that hosts a specified shard including the specified key; and
instructions for returning, by the server computing device, the specified value to the client computing device.

17. The computer-readable storage medium of claim 16, wherein the instructions for retrieving the specified value include:
instructions for storing a set of values in a distributed cache associated with the server computing device, and
instructions for retrieving the specified value from the distributed cache.

18. The computer-readable storage medium of claim 16, wherein the instructions for converting include instructions for converting the multiple data items into the multiple key-value pairs based on registration data associated with a first application, the registration data indicating a first set of attributes of the data item as the key and the second set of multiple attributes as the value of the key.

19. A system, comprising:
a processor;
a first component configured to convert multiple data items stored in a first data source into multiple key-value pairs, wherein a key-value pair of the multiple key-value pairs includes a first set of attributes of a data item as a key, and a second set of attributes of the data item as a value of the key;
a second component configured to:
generate multiple shards, wherein each of the multiple shards includes a subset of the multiple-key value pairs, and
assigning different shards to different publisher nodes; and
a third component configured to receive from each of the publisher nodes a list of shards hosted by the corresponding publisher node, wherein the third component is further configured to return, in response to receiving a data access request from a client computing device for a specified value of a specified key, access information of a specified publisher node of the publisher nodes storing a specified shard including the specified key, and
wherein the specified publisher node is configured to return the specified value to the client computing device.

20. The system of claim 19, wherein the second component is configured to store the multiple shards in a key-value storage system and as separate instances of the key-value storage system.
